(19) United States
(12) Patent Application Publication
(10) Pub. No.: US 2010/0034244 A1
(43) Pub. Date: Feb. 11, 2010

(54) WIRELESS FIXED TERMINAL

(76) Inventor: Yang ZHAO, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/571,479

(22) Filed: Oct. 1, 2009

Related U.S. Application Data
(63) Continuation of application No. PCT/CN2008/000719, filed on Apr. 9, 2008.

(30) Foreign Application Priority Data
Apr. 10, 2007 (CN) 200720141441.9

(51) Int. Cl. H04B 1/38; H04B 14/04

(52) U.S. Cl. 375/220; 375/222; 375/242

(57) ABSTRACT

A wireless fixed terminal is provided. The wireless fixed terminal includes a speaker, configured to output an analog audio signal, a first modem unit, configured to receive a radio signal from the wireless communication network and demodulate the radio signal into a digital signal, modulate the received digital signal and send the digital signal to the wireless communication network. The wireless fixed terminal also includes a converting unit, configured to convert the digital signal demodulated by the first modem unit to an analog signal and output the analog signal to the speaker, and convert an analog signal from the speaker to a digital signal and output the digital signal to the first modem unit, and a second modem unit, configured to modulate the digital signal demodulated by the first modem unit and send the modulated signal to a wired terminal, and demodulate an analog signal from the wired terminal into a digital signal and output the digital signal to the first modem unit.

### CROSS-REFERENCE TO RELATED APPLICATION

This application is a continuation application of PCT/CN2008/000719, filed on Apr. 9, 2008, which claims priority to Chinese Patent Application No. 200720141441.9, filed with the Chinese Patent Office on Apr. 10, 2007 and entitled “Wireless Fixed Terminal”, both of which are incorporated herein by reference in their entireties.

### TECHNICAL FIELD

The present disclosure relates to the telecommunication technology field, and in particular, to a wireless fixed terminal.

### BACKGROUND

The conventional wireless fixed terminal (phone-style wireless fixed terminal), whose appearance is similar to the appearance of a fixed-line phone, has a handset, a keypad (KPAD), and a liquid crystal display (LCD). A wireless fixed terminal can be used to make a call in the same way as a common telephone. Instead of accessing the Public Switched Telephone Network (PSTN) through a telephone line, the wireless fixed terminal accesses the telephone network with a wireless technology, such as the Global System for Mobile communications (GSM) and Code Division Multiple Access (CDMA), or in other wireless modes to communicate with other fixed telephone subscribers or mobile telephone subscribers.

At present, a conventional phone-style wireless fixed terminal, whose appearance is similar to the appearance of a common fixed telephone, can be used to make a call or send a short message. Generally, a wireless fixed terminal accesses a base station with the GSM or CDMA technology to implement voice and SMS services in the same principle as that of a mobile telephone. A wireless fixed terminal is not expensive and can be fixed at home. Such a wireless fixed terminal, however, cannot be connected to a wired extension or an analog electrograph because no relevant interfaces or circuits exist when a subscriber wants to implement the analog fax function with a wireless technology. FIG. 1 shows a structure of a conventional phone-style wireless fixed terminal in the related art. The wireless fixed terminal has many General Purpose Input/Output (GPIO) pins on its baseband chip. These pins may be defined by the software. Most of pins are defined as the LCD parallel interfaces, the interfaces for a keyboard, interfaces for a Microphone (MIC), interfaces for a buzzer, and interfaces for a handset. Almost all the GPIO pins on the wireless fixed terminal are used due to the product shape of the phone-style wireless fixed terminal.

However, almost all the GPIO pins on a conventional phone-style wireless fixed terminal are occupied, and if the wireless fixed terminal needs to be externally connected to a wired terminal, such as a fixed telephone, an electrograph, with the conventional technology, no interfaces are available for externally connecting to a wired terminal.

### SUMMARY

A wireless fixed terminal is provided herein. The provided wireless fixed terminal may address issues that can occur when no interfaces are available for externally connecting to the wired terminal with the conventional technology, so that the wireless fixed terminal may be connected to a wired terminal.

A wireless fixed terminal is provided in an embodiment of the disclosure. The terminal includes:

a speaker, adapted to output an analog audio signal;

a first modem unit, adapted to: receive a radio signal from the wireless communication network, and demodulate the radio signal into a digital signal; modulate the received digital signal, and send the digital signal to the wireless communication network;

a converting unit, adapted to: convert the digital signal demodulated by the first modem unit to an analog signal, and output the analog signal to the speaker; convert an analog signal from the speaker to a digital signal, and output the digital signal to the first modem unit; and

a second modem unit, adapted to: modulate the digital signal demodulated by the first modem unit, and send the modulated signal to a wired terminal; demodulate an analog signal from the wired terminal into a digital signal, and output the digital signal to the first modem unit.

The first modem unit provided in an embodiment of the disclosure demodulates the received radio signal from the wireless communication network into a digital signal, and sends the digital signal to the wireless communication network. The converting unit performs digital-to-analog conversion or analog-to-digital conversion between the first modem unit and the speaker. The second modem unit modulates or demodulates the signals between the first modem unit and the wired terminal. In this way, the problem of failing to externally connect to an extension with the conventional technology by a wireless fixed terminal is solved. A wireless fixed terminal may implement voice calls and be externally connected to a wired terminal. Therefore, more services may be provided.

### BRIEF DESCRIPTION OF THE DRAWINGS

FIG. 1 shows a structure of a wireless fixed terminal with the conventional technology in the related art;

FIG. 2 shows a structure of a wireless fixed terminal provided in an embodiment of the disclosure;

FIG. 3 shows a structure of a wireless fixed terminal provided in another embodiment of the disclosure;

FIG. 4 shows a structure of a wireless fixed terminal provided in still another embodiment of the disclosure; and

FIG. 5 shows a circuit in a wireless fixed terminal provided in an embodiment of the disclosure to achieve a Pulse Code Modulation (PCM) speech path by connecting a baseband chip externally to a Coder-decoder (CODEC).

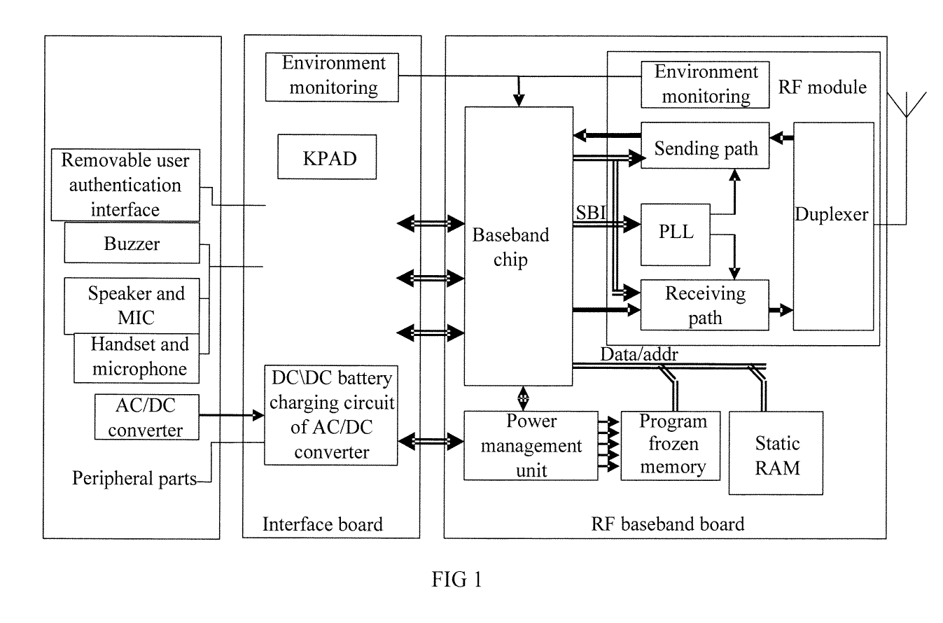

### DETAILED DESCRIPTION

A wireless fixed terminal provided in an embodiment of the disclosure includes: a speaker, adapted to output an analog audio signal; a first modem unit, adapted to receive a radio signal from the wireless communication network and demodulate the radio signal into a digital signal, and modulate the received digital signal and send the digital signal to the wireless communication network; a converting unit, adapted to convert the digital signal demodulated by the first modem unit to an analog signal and output the analog signal to the speaker, and convert an analog signal from the speaker to a digital signal and output the digital signal to the first modem unit; and a second modem unit, adapted to modulate the digital signal demodulated by the first modem unit and send the modulated signal to a wired terminal, and demodulate an analog signal from the wired terminal into a digital signal and output the digital signal to the first modem unit. With the wireless fixed terminal provided in the disclosure, the problem of failing to externally connect to an extension with the conventional technology by a wireless fixed terminal is solved. A wireless fixed terminal can implement voice calls and be externally connected to a wired terminal. Therefore, more services are provided.

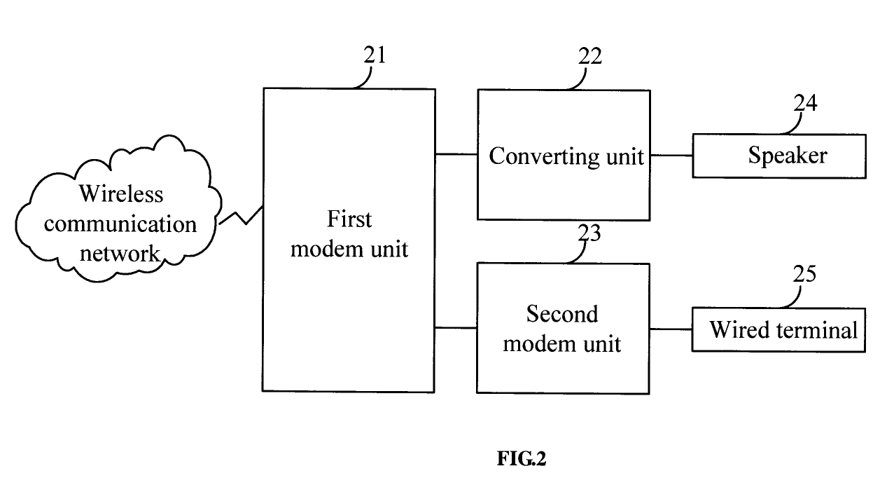

FIG. 2 shows a schematic structure of a wireless fixed terminal provided in one embodiment of the disclosure. The wireless fixed terminal includes:

a speaker 24, adapted to output an analog audio signal;

a first modem unit 21, adapted to receive a radio signal from the wireless communication network, and demodulate the radio signal into a digital signal; modulate the received digital signal and send the digital signal to the wireless communication network;

a converting unit 22, adapted to convert the digital signal demodulated by the first modem unit 21 to an analog signal, and output the analog signal to the speaker 24; convert an analog signal from the speaker 24 to a digital signal and output the digital signal to the first modem unit 21; and

a second modem unit 23, adapted to modulate the digital signal demodulated by the first modem unit 21 and send the modulated signal to the wired terminal 25; demodulate an analog signal from the wired terminal 25 to a digital signal and output the digital signal to the first modem unit 21.

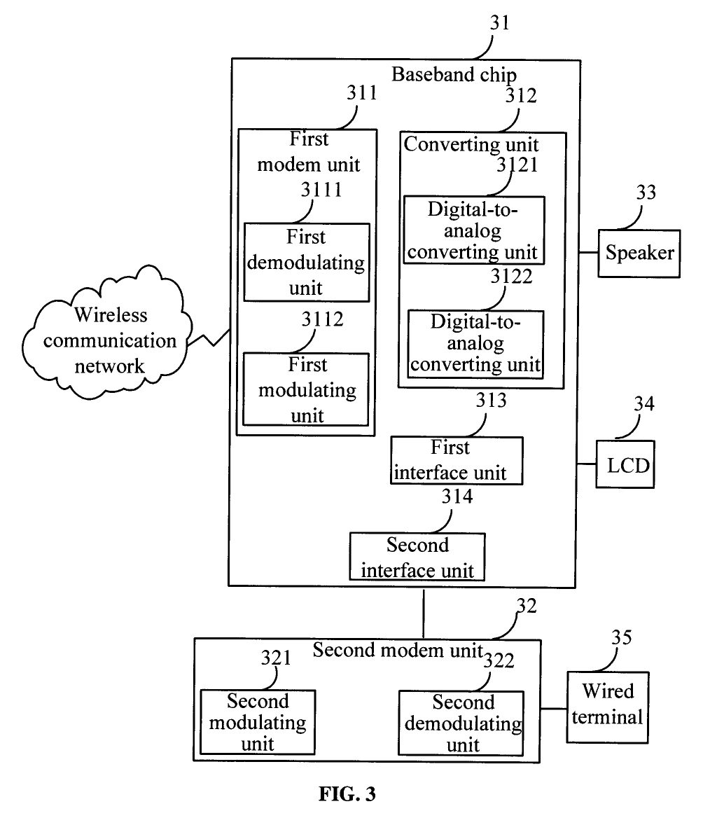

FIG. 3 shows a structure of a wireless fixed terminal provided in another embodiment of the disclosure. The wireless fixed terminal includes a baseband chip 31, a second modem unit 32, a speaker 33, and an LCD 34.

The baseband chip 31 includes a first modem unit 311, a converting unit 312, a first interface unit 313, and a second interface unit 314.

The first modem unit 311 includes a first demodulating unit 3111 and a first modulating unit 3112.

The converting unit 312 includes a digital-to-analog converting unit 3121 and an analog-to-digital converting unit 3122.

The second modem unit 32 includes a second modulating unit 321 and a second demodulating unit 322.

The first modem unit 311 is adapted to receive a radio signal from the wireless communication network, and demodulate the radio signal into a digital signal; modulate the received digital signal, and send the digital signal to the wireless communication network.

The first demodulating unit 3111 is adapted to receive a radio signal from the wireless communication network and demodulate the radio signal into a digital signal.

The first modulating unit 3112 is adapted to modulate the received digital signal and send the modulated signal to the wireless communication network.

The converting unit 312 is adapted to convert the digital signal demodulated by the first modem unit 311 to an analog signal, and output the analog signal to the speaker 33; and convert an analog signal from the speaker 33 to a digital signal, and output the digital signal to the first modem unit 311.

The digital-to-analog converting unit 3121 is adapted to convert the digital signal demodulated by the first modem unit 311 to an analog signal and output the analog signal to the speaker 33.

The analog-to-digital converting unit 3122 is adapted to convert an analog signal from the speaker 33 to a digital signal and output the digital signal to the first modem unit 311.

The converting unit 312 implements the first route of PCM speech path through the Coder-decoder (CODEC) embedded on the baseband chip 31.

The first interface unit 313 is adapted to provide a serial interface for the LCD 34.

The second interface unit 314 is adapted to provide an interface for the second modem unit 32.

The second modem unit 32 is adapted to modulate the digital signal demodulated by the first modem unit 311, and output the modulated signal to the wired terminal 35; demodulate the analog signal from the wired terminal 35 to a digital signal, and output the digital signal to the first modem unit 311.

The second modem unit 32 implements the second route of PCM speech path through the CODEC externally connected to the baseband chip 31.

The second modulating unit 321 is adapted to modulate the digital signal demodulated by the first modem unit 311, and output the demodulated signal to the wired terminal 35.

The second demodulating unit 322 is adapted to demodulate the analog signal from the wired terminal 35 to a digital signal, and output the digital signal to the first modem unit 311.

The RJ11 interface is an interface between the second modem unit 32 and the wired terminal 35.

The signal may be an audio signal. The wired terminal 35 may be a cable telephone.

The wired terminal 35 may also be a counter, an electrograph or a private branch switch.

The structure and principles of a wireless fixed terminal provided in an embodiment of the disclosure are described below.

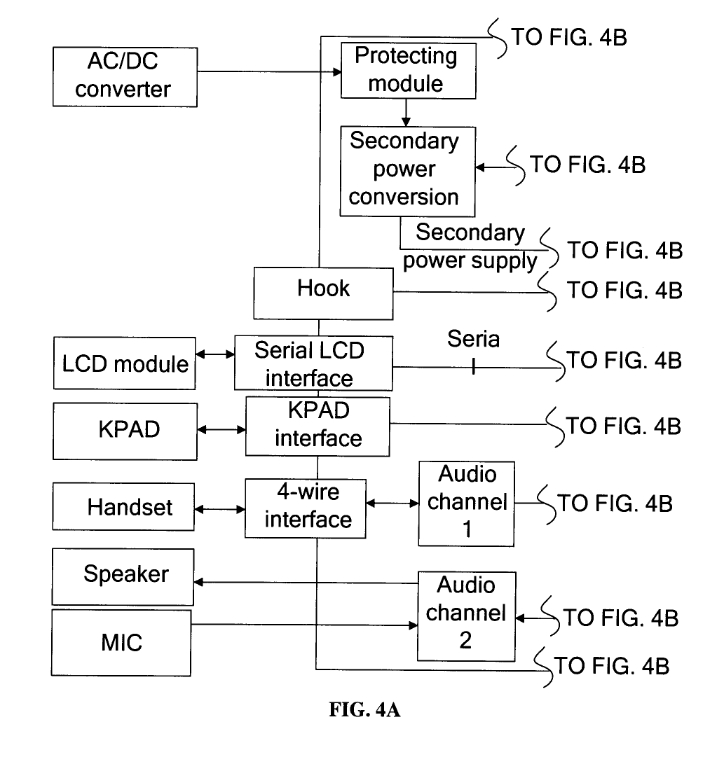

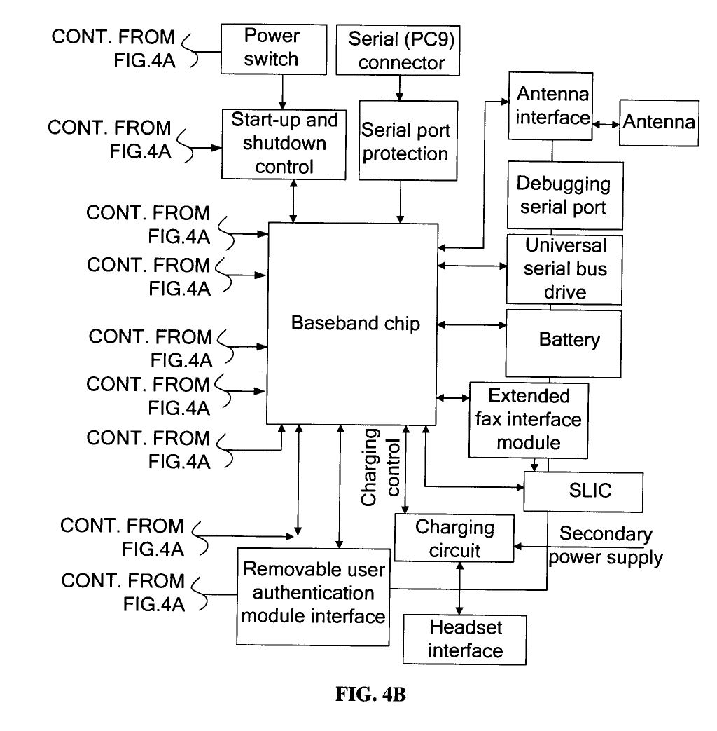

FIG. 4 shows a simple structure of the wireless fixed terminal provided in still another embodiment of the disclosure. The wireless fixed terminal includes: a Direct Current/Direct Current (DC/DC) converter power supplier, a serial interface module, a Subscriber Line Interface Circuit (SLIC) module, an extended fax interface module, an indicator module, a Removable User Identity Module (R_UIM) interface, a battery charge and discharge control circuit, a start-up and shutdown control circuit, an environment variable monitoring module, a first audio channel 1, a second audio channel 2, an LCD interface, a KPAD interface, and a hook switch.

Two channels of PCM speech paths are available on the baseband chip. Only one channel of the PCM speech path is available for a conventional product. In the disclosure, an object that two channels of PCM speech paths work at the same time is realized.

A channel of PCM path is directly connected to the audio processing and Digital Signal Processing (DSP) and the Coder-decoder (CODEC) inside the baseband chip. In this case, an audio interface and a ringing interface are available on the baseband chip for being connected to the MIC and speaker directly. This channel of PCM path can be used to implement the services of phone-style fixed terminal.

In the conventional phone-style wireless fixed terminal, the other channel of PCM path cannot be connected to the same audio DSP and CODEC. The PCM path is idle in the conventional phone-style wireless fixed terminal. The path, however, can be used to transmit signals to GPIO on the baseband chip in the software setting mode. For example, The external DSP and CODEC chip implement the application of the other channel of PCM speech path, The external DSP and CODEC chip plus the circuits for the SLIC module (external audio DSP and CODEC) and fax module enable a subscriber to externally connect an extension and to implement the functions of faxing and externally connecting to a counter.

The PCM speech path can be implemented through the built-in CODEC function on the baseband chip. That is, a voice interface with the built-in CODEC is available on the baseband chip module and used to connect the external audio channels: a first audio channel 1 and a second audio channel 2.

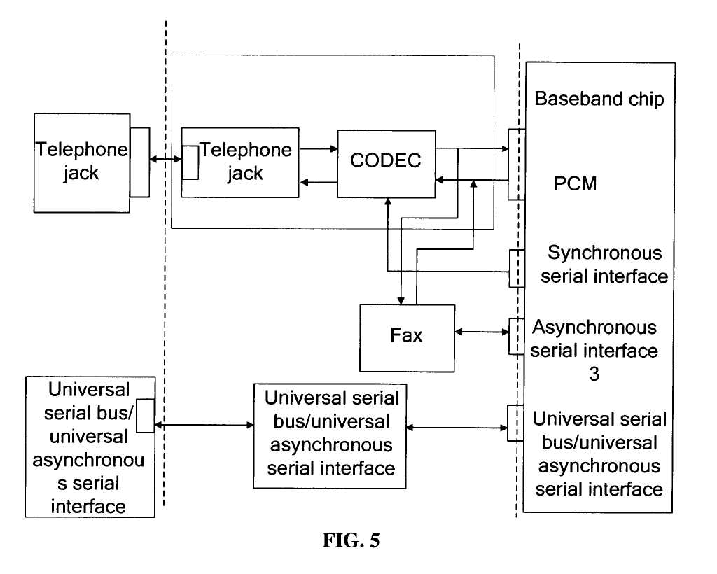

FIG. 5 shows a circuit of a PCM speech path that is implemented by externally connecting the baseband chip to a CODEC chip in the wireless fixed terminal provided in the disclosure. The circuit includes an analog channel (except the G3 faxing function) of the fixed terminal interface processing unit which is formed by placing the SLIC interface module of the CODEC chip between a voice CODEC inside the wireless baseband processing chip and a terminal subscriber. The analog channel is used to receive and send a voice signal, send the ringing tone and signal tone, (including the dial tone, busy tone, howler tone, and service prompt tone and so on) to a common telephone, send a calling number to a common telephone, and receive the number that is dialed by a subscriber with a telephone.

The SLIC inside a board is externally connected to a telephone, and serves as an important circuit for a call. An SLIC interface module is located between a voice CODEC and an end user and used to form an analog channel of a fixed station interface processing unit. The analog channel is used to receive and send a voice signal, send the ringing tone and signal tone, such as the dial tone, busy tone, howler tone, and service prompt tone, to a common telephone, send a calling number to a common telephone, and receive the number that is dialed by a subscriber with a telephone.

Three interfaces, that is, a PCM code stream interface, a Serial Peripheral Interface (SPI), and a subscriber line voice interface connected to an external telephone are available for an SLIC module and other units.

The PCM interface, as a digital audio interface for the SLIC chip and baseband chip, is used to transmit digital signals of telephony voice in the PCM format through an inter-board interface.

The Serial Peripheral Interface (SPI), as an interface of the SPI bus, is used to set the parameters and collect the information for the SLIC by a wireless baseband module through an inter-board interface.

In FIG. 5, the part between two dotted lines indicates a fixed station user interface module. The part in the dotted box indicates an SLIC subsystem. The subsystem provides the functions of the SLIC, CODEC, DC-DC circuit, Dual-Tone Multifrequency (DTMF) detection, and other functions related to the process of producing signals required by an analog telephone. Specially, the subsystem provides the BORSCHT function, that is, the Battery, Overvoltage, Ringing, Supervision, CODEC, Hybrid, and Test functions.

The working process of a wireless fixed terminal provided in an embodiment of the disclosure is described below.

Sending path: An analog voice signal from a telephone is transmitted to the RJ11 interface on an interface board through a telephone line, and then to the SLIC chip. On the chip, the voice signal is converted to an analog voice signal through the SLIC, and coded by the CODEC to output the standard PCM code stream, and then the code stream is sent to the PCM interface of a wireless baseband module.

Receiving path: The voice data from the peer end is transmitted to the CODEC unit of the SLIC chip through a PCM interface on the wireless baseband module. The CODEC unit restores the digital signal into an analog voice signal, modulates the analog voice signal to a telephone line through the SLIC, and then sends the analog voice signal to a telephone.

The DTMF signal that is produced by a KPAD on the telephone is processed by the SLIC and CODEC on the chip, and converted to a binary coded key value, and then reported to the wireless baseband module through an SPI.

The ringing tone, signal tone, service prompt tone, and calling number are produced and controlled by the main control module of the wireless baseband module. The wireless baseband module writes the relevant parameters and commands into the CODEC through an SPI. After the CODEC produces the corresponding signal, the signal is sent to a telephone through the SLIC.

An interface is available on the facsimile (fax) expanding interface module for expanding a fax board. The interface can be used as an asynchronous serial interface and a PCM interface. The fax board functions to perform bidirectional conversion of 64 kbit/s digital PCM code stream and fax data or signaling, such as the V.21 protocol.

The principle for two routes of PCM speech paths that work together is as follows:

The first route of PCM speech path is implemented through the built-in CODEC on the baseband chip to perform phone-style conversation. Many interfaces, including an LCD interface, a KPAD interface, an MIC interface, a buzzer interface, and a handset interface, may be available for implementing a complete phone-style conversation. Many GPIO pins may be used. To reduce the number of GPIO pins, use a serial LCD interface. In this case, five to six GPIO pins can be reduced. Only two pins of the serial LCD interface are required on the baseband chip for the GPIO of the serial clock (SCL) and the serial data (SDA). If the sampling of the data line is performed along the rising edge of the SCL clock, five to six pins can be reduced in comparison with the condition when a parallel LCD interface is used. The idle pins on the baseband chip can be configured as the other PCM speech path.

On the basis of the implementation of the first route of PCM speech path, at least eight PCM pins are re-defined, with four pins for receiving signals and the other four pins for sending signals. These pins are connected to an external SLIC chip to form the other route of PCM speech path. The external interface is an RJ11 interface and can be connected to a telephone directly.

The wireless fixed terminal provided in this embodiment implements the function of public telephone by being externally connected to a counter. This terminal implements the charging function by connecting a counter serially between an RJ11 interface and a telephone. This terminal also supports the external connection of a PBX switch.

To sum up, the solution in the disclosure combines the advantages in the conventional wireless fixed terminal, and improves the performance of the product. If a few of rooms exist at a customer's home, a host telephone can be used for conversation. If many rooms exist at a customer's home, extensions can be externally connected. A customer can easily connect a host telephone to an analog electrograph for analog fax service, or connect the host telephone externally to a counter for charging, or connect the host telephone externally to a PBX for conversation through an interface on the host telephone.

Obviously, those skilled in the art can make modifications and variations to the disclosure without departing from the spirit and scope of the disclosure. The disclosure is intended to cover all these modifications and variations provided that they fall in the scope of the claims and equivalent technologies of the disclosure.

What is claimed is:

1. A wireless fixed terminal, comprising:
a speaker, configured to output an analog audio signal;
a first modem unit, configured to receive a radio signal from a wireless communication network, and demodulate the radio signal into a digital signal; and modulate the digital signal, and send the digital signal to the wireless communication network;
a converting unit, configured to convert the digital signal demodulated by the first modem unit to an analog signal, and output the analog signal to the speaker; and convert the analog audio signal from the speaker to a digital signal, and output the converted digital signal to the first modem unit; and
a second modem unit, configured to modulate the digital signal demodulated by the first modem unit, and send the modulated signal to a wired terminal; and demodulate an analog signal from the wired terminal into a digital signal and output the digital signal demodulated from the analog signal to the first modem unit.

2. The wireless fixed terminal according to claim 1, wherein the first modem unit comprises:
a first demodulating unit, configured to receive the radio signal from the wireless communication network, and demodulate the radio signal into a digital signal; and
a first modulating unit, configured to modulate the received digital signal, and send the modulated signal to the wireless communication network.

3. The wireless fixed terminal according to claim 1, wherein the converting unit comprises:
a digital-to-analog converting unit, configured to convert the digital signal demodulated by the first modem unit to an analog signal, and send the analog signal to the speaker; and
an analog-to-digital converting unit, configured to convert the analog signal from the speaker to a digital signal, and output the digital signal to the first modem unit.

4. The wireless fixed terminal according to claim 1, wherein the second modem unit comprises:
a second modulating unit, configured to modulate the digital signal demodulated by the first modem unit, and output the modulated signal to the wired terminal; and
a second demodulating unit, configured to demodulate the analog signal from the wired terminal to a digital signal, and output the digital signal to the first modem unit.

5. The wireless fixed terminal according to claim 1, further comprising an RJ11 interface between the second modem unit and the wired terminal.

6. The wireless fixed terminal according to claim 1, wherein the wired terminal comprises at least one of a cable telephone, a counter, an electrograph or a special branching switch.

7. The wireless fixed terminal according to claim 1, wherein the first modem unit and the converting unit implement a route of speech path through a baseband chip.

8. The wireless fixed terminal according to claim 7, wherein the wired terminal comprises a liquid crystal display (LCD), and the baseband chip comprises:
a first interface unit, configured to provide a serial interface for the LCD; and
a second interface unit, configured to provide an interface for the second modem unit.

9. The wireless fixed terminal according to claim 7, wherein the converting unit implements a first channel of a Pulse Code Modulation (PCM) speech path through a Coder-decoder (CODEC) embedded in the baseband chip.

10. The wireless fixed terminal according to claim 7, wherein the second modem unit implements a second channel of the PCM speech path through the CODEC externally connected to the baseband chip.

11. A wireless fixed terminal, comprising:
a baseband chip;
and Subscriber Line Interface Circuits (SLICs), wherein:
the SLICs are connected to a Pulse Code Modulation (PCM) interface of the baseband chip and a Serial Peripheral Interface (SPI) respectively;
the SLIC is configured to form a route of PCM speech path between the baseband chip and the terminal;
the PCM interface is configured to transmit digital signals of telephony voice between the SLIC and the baseband chip in PCM format; and
the baseband chip is configured to collect the information about the SLIC through the SPI, and set the parameters of the SLIC.

12. A method for externally connecting to an extension, comprising:
demodulating, by a first modem unit, a radio signal received from a wireless communication network into a digital signal, and sending the digital signal to the wireless communication network;
performing, by a converting unit, digital-to-analog conversion or analog-to-digital conversion between the first modem unit and a speaker;
modulating or demodulating, by a second modem, signals between the first modem unit and a wired terminal.

13. The method for externally connecting to an extension according to claim 12, wherein performing, by a converting unit, digital-to-analog conversion or analog-to-digital conversion between the first modem unit and a speaker comprises:
converting the digital signal demodulated by the first modem unit to an analog signal, and outputting the analog signal to the speaker; or
converting an analog signal from the speaker to a digital signal, and outputting the digital signal to the first modem unit.

14. The method for externally connecting to an extension according to claim 12, wherein modulating or demodulating signals between the first modem unit and a wired terminal by a second modem comprises:
modulating the digital signal demodulated by the first modem unit, and sending the modulated signal to the wired terminal; or
demodulating an analog signal from the wired terminal into a digital signal, and outputting the digital signal to the first modem unit.
